(19) United States
(12) Patent Application Publication
(10) Pub. No.: US 2026/0261465 A1
(43) Pub. Date: Sep. 3, 2026

(54) Methods For Receiving Data Channel In Mobile Communications

(71) Applicant: MediaTek Inc., Hsinchu City (TW)

(72) Inventors: Chia-Hao Yu, Hsinchu City (TW); Jiann-Ching Guey, Hsinchu City (TW); Lung-Sheng Tsai, Hsinchu City (TW); Tzu-Han Chou, San Jose, CA (US); Chien-Hwa Hwang, Hsinchu City (TW); Pei-Kai Liao, Hsinchu City (TW); Qian Cheng, San Jose, CA (US)

(73) Assignee: MediaTek Inc., Hsinchu City (TW)

(21) Appl. No.: 19/546,402

(22) Filed: Feb. 22, 2026

Related U.S. Application Data
(60) Provisional application No. 63/765,881, filed on Mar. 3, 2025.

(51) Int. Cl. H04L 27/26; H04L 1/00; H04L 1/1829; H04L 5/00

(52) U.S. Cl. CPC H04L 27/261; H04L 1/0058; H04L 1/1864; H04L 5/0007

(57) ABSTRACT

Various solutions for receiving data channel with respect to an apparatus in mobile communications are described. The apparatus may receive a Demodulation Reference Signal (DMRS) configuration for a data channel. The apparatus may receive a configuration for the data channel. The configuration may include: (1) a first Resource Element (RE) time-frequency pattern of the data channel, wherein the first RE time-frequency pattern may be associated with a first equivalent code rate; and (2) a second RE time-frequency pattern of the data channel, wherein the second RE time-frequency pattern may be associated with a second equivalent code rate which is lower than the first equivalent code rate. The apparatus may receive a signaling indicating transmission of a scheduled data channel and the first equivalent code rate of the scheduled data channel based on the DMRS configuration and the configuration.

### CROSS REFERENCE TO RELATED PATENT APPLICATION(S)

The present disclosure is part of a non-provisional application claiming the priority benefits of U.S. Patent Application No. 63/765,881, filed on 3 March 2025, the content of which herein being incorporated by reference in its entirety.

### TECHNICAL FIELD

The present disclosure is generally related to mobile communications and, more particularly, to receiving data channel with respect to apparatus in mobile communications.

### BACKGROUND

Unless otherwise indicated herein, approaches described in this section are not prior art to the claims listed below and are not admitted as prior art by inclusion in this section.

With the evolution of mobile communication systems beyond fifth generation (5G) New Radio (NR), system bandwidth and antenna configurations continue to expand to support higher data rates and spectral efficiency. For example, channel bandwidth increases from a maximum of 273 Resource Blocks (RBs) in 5G NR to 544 RBs in newly developed systems, and the number of receive antennas at a User Equipment (UE) increases from four to eight, resulting in a substantially larger sample buffer requirement. To achieve reliable demodulation and decoding performance under such expanded configurations, the UE may need to wait for a second Demodulation Reference Signal (DMRS) symbol to perform channel estimation before initiating Physical Downlink Shared Channel (PDSCH) decoding, even when a per-symbol transport block (TB) structure is employed. Assuming a channel estimation processing time comparable to that of 5G NR, the buffering requirement per carrier may increase by approximately four times. In addition, supporting an increased number of spatial layers or antenna ports, particularly for Single-User Multiple-Input Multiple-Output (SU-MIMO) transmissions, may require additional orthogonal DMRS ports, thereby increasing DMRS overhead, for example, up to approximately twice that of 5G NR.

To reduce DMRS overhead, some approaches have been proposed in which data symbols are first demodulated and subsequently re-modulated for use in channel estimation. In some scenarios, channel estimation and noise estimation may initially be performed based on DMRS Resource Elements (REs) on a first Orthogonal Frequency-Division Multiplexing (OFDM) symbol. Data REs on a subsequent OFDM symbol may then be demodulated using the obtained channel information, and the demodulated symbols may be regenerated and used as reference signals for further channel estimation. This process may be iteratively applied across multiple OFDM symbols.

However, such approaches may suffer from several limitations. In particular, demodulation robustness may be degraded when channel estimation accuracy based on an earlier DMRS symbol is insufficient, which may lead to error propagation during re-modulation and subsequent channel estimation. Moreover, regenerating data REs on a per-OFDM-symbol basis may significantly increase UE processing complexity and power consumption.

Accordingly, there remains a need for improved mechanisms that can reduce DMRS overhead and buffering latency while maintaining reliable channel estimation and manageable UE complexity in advanced mobile communication systems.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to receiving data channel with respect to apparatus in mobile communications.

In one aspect, a method may involve an apparatus receiving a Demodulation Reference Signal (DMRS) configuration for a data channel. The method may also involve the apparatus receiving a configuration for the data channel. The configuration may include:
(1) a first Resource Element (RE) time-frequency pattern of the data channel, wherein the first RE time-frequency pattern may be associated with a first equivalent code rate; and
(2) a second RE time-frequency pattern of the data channel, wherein the second RE time- frequency pattern may be associated with a second equivalent code rate which is lower than the first equivalent code rate, the second RE time-frequency pattern may be associated with a subset of Orthogonal Frequency Division Multiplexing (OFDM) symbols of the data channel, and the first RE time- frequency pattern and the second RE time-frequency pattern may be used for transmission of the data channel. The method may also involve the apparatus receiving a signaling indicating transmission of a scheduled data channel and the first equivalent code rate of the scheduled data channel based on the DMRS configuration and the configuration.

The method may also involve the apparatus transmitting a DMRS configuration for a data channel. The method may also involve the apparatus transmitting a configuration for the data channel. The configuration may include: (1) a first RE time-frequency pattern of the data channel, wherein the first RE time-frequency pattern may be associated with a first equivalent code rate; and (2) a second RE time-frequency pattern of the data channel, wherein the second RE time-frequency pattern may be associated with a second equivalent code rate which is lower than the first equivalent code rate, the second RE time- frequency pattern may be associated with a subset of OFDM symbols of the data channel, and the first RE time-frequency pattern and the second RE time- frequency pattern may be used for transmission of the data channel. The method may also involve the apparatus transmitting a signaling indicating transmission of a scheduled data channel and the first equivalent code rate of the scheduled data channel based on the DMRS configuration and the configuration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (loT) and Narrow Band Internet of Things (NB-loT), Industrial Internet of Things (IloT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTIONOF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to receiving data channel with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a DMRS configuration for a data channel to a UE. The network node may transmit a configuration for the data channel to the UE. The configuration may include: (1) a first RE time-frequency pattern of the data channel and (2) a second RE time-frequency pattern of the data channel. The first RE time- frequency pattern may be associated with a first equivalent code rate. The second RE time-frequency pattern may be associated with a second equivalent code rate which is lower than the first equivalent code rate. The second RE time-frequency pattern may be associated with a subset of OFDM symbols of the data channel. The first RE time-frequency pattern and the second RE time- frequency pattern may be used for transmission of the data channel. The UE may receive the DMRS configuration and the configuration from the network node. The network node may transmit a signaling. The signaling may indicate: (1) transmission of a scheduled data channel and (2) the first equivalent code rate of the scheduled data channel based on the DMRS configuration and the configuration.

Based on the DMRS configuration, the configuration and the signaling, the network node may transmit a data channel, such as a Physical Downlink Shared Channel (PDSCH), to the UE. According to the DMRS configuration, the PDSCH may include DMRS REs on a first symbol. The UE may perform a channel estimation to determine a first channel information associated with the first symbol using the DMRS REs on the first symbol. According to the first RE time-frequency pattern, the PDSCH may include a plurality of data REs. According to the second RE time-frequency pattern, the PDSCH may include a portion of a plurality of REs on a second symbol. Based on the first channel information, the UE may determine a channel information associated with the portion of the plurality of REs on the second symbol. The UE may determine a second channel information associated with the second symbol based on the channel information associated with the portion of the plurality of REs. Further, the UE may determine at least one third channel information on at least one third symbol based on the first channel information and the second channel information. The at least one third symbol may be between the first symbol and the second symbol.

Accordingly, since channel information associated with different symbols may be derived without relying solely on additional reference signal symbols or per-symbol data regeneration, the DMRS overhead and buffering latency may be reduced while maintaining reliable channel estimation and manageable UE complexity.

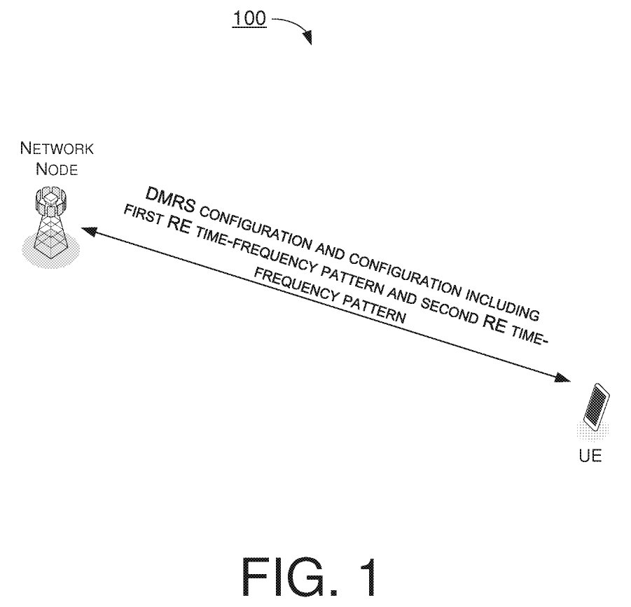

FIG. 1 illustrates an example scenario 100 under schemes in accordance with implementations of the present disclosure. Scenario 100 involves at least one network node, a UE, which may be a part of a wireless communication network (e.g., an LTE network, a 5G/NR network, an loT network or a 6G network). Scenario 100 illustrates the current network framework. The UE may connect to the network side. The network side may comprise one or more than one network nodes.

In some embodiments, the network node may transmit a DMRS configuration for a data channel, such as a PDSCH, to the UE. The network node may transmit a configuration for the PDSCH to the UE. The configuration may include: (1) a first RE time-frequency pattern of the PDSCH and (2) a second RE time-frequency pattern of the PDSCH.

In some implementations, the first RE time-frequency pattern may include a plurality of data REs and be associated with a first equivalent code rate. The second RE time-frequency pattern may include a portion of a plurality of REs mapped to an OFDM symbol and be associated with a second equivalent code rate which is lower than the first equivalent code rate. More specifically, the plurality of REs mapped to the OFDM symbol may include: (1) the portion of the plurality of REs, including DMRS REs with data (i.e., data- loaded DMRS REs), and (2) the rest of the plurality of REs, including data REs.

In some implementations, the second RE time-frequency pattern including the portion of the plurality of REs may occupy a subset of OFDM symbols. The first RE time-frequency pattern and the second RE time- frequency pattern may be used for transmission of the PDSCH channel simultaneously. The UE may receive the DMRS configuration and the configuration from the network node. The network node may transmit a signaling. The signaling may indicate: (1) transmission of a scheduled PDSCH and (2) the first equivalent code rate of the scheduled PDSCH based on the DMRS configuration and the configuration.

In some implementations, based on the previous configurations, the network node may transmit a PDSCH (i.e., the scheduled PDSCH) to the UE. According to the DMRS configuration, the PDSCH may include DMRS REs on a first symbol. The UE may perform a channel estimation to determine a first channel information associated with the first symbol using the DMRS REs on the first symbol. According to the first RE time-frequency pattern, the PDSCH may include a plurality of data REs. According to the second RE time- frequency pattern, the PDSCH may further include a portion of a plurality of REs on a second symbol. More specifically, the plurality of REs on the second symbol may include: (1) data REs, and (2) DMRS REs with data (i.e., data- loaded DMRS REs).

In some implementations, based on the first channel information, the UE may determine a channel information associated with the portion of the plurality of REs on the second symbol. In particular, based on the first channel information, the UE may determine the channel information associated with the portion of the plurality of REs on the second symbol by performing an operation that may derive the channel information on the second symbol from the first channel information by accounting for channel variation between the first symbol and the second symbol.

More specifically, the operation may include an extrapolation. The extrapolation may be performed by projecting the first channel information from the first symbol to the second symbol based on at least one of the time-domain channel variation or the frequency-domain channel variation. For example, the extrapolation is performed using a linear projection that assumes a substantially linear channel variation between the first symbol and the second symbol.

In some implementations, based on the channel information associated with the portion of the plurality of REs, the UE may determine a second channel information associated with the second symbol. In particular, based on the channel information associated with the portion of the plurality of REs, the UE may determine the second channel information associated with the second symbol by performing an operation that estimates channel coefficients for data REs on the second symbol from channel coefficients associated with the portion of the plurality of REs within the second symbol.

More specifically, the operation may include an interpolation between two reference REs of the portion of the plurality of REs. The interpolation may be performed by estimating channel coefficients for REs (i.e., the data REs) on the second symbol based on channel coefficients of reference REs (i.e., the data-loaded DMRS REs) in at least one of time domain and frequency domain. For example, the interpolation is performed using a linear interpolation that assumes a substantially linear channel variation between the data-loaded DMRS REs.

In some implementations, based on the first channel information and the second channel information, the UE may determine at least one third channel information on at least one third symbol. In particular, the at least one third symbol may be between the first symbol and the second symbol. Based on the first channel information and the second channel information, the UE may determine the at least one third channel information on the at least one third symbol by performing an operation that estimates channel information on the at least one third symbol based on channel variation between the first symbol and the second symbol.

In some implementations, based on the channel information associated with the DMRS of the first symbol and the channel information associated with the plurality of REs of the second symbol, the UE may determine at least one third channel information on at least one third symbol. In particular, the at least one third symbol may be between the first symbol and the second symbol. Based on the channel information associated with the DMRS of the first symbol and the channel information associated with the plurality of REs of the second symbol, the UE may determine the at least one third channel information on the at least one third symbol by performing an operation that estimates channel information on the at least one third symbol based on channel variation between the first symbol and the second symbol.

More specifically, the operation may include an interpolation. The interpolation may be performed by estimating channel coefficients on the at least one third symbol based on channel coefficients of the first symbol and the second symbol in at least one of the time domain or the frequency domain. For example, the interpolation is performed using a linear interpolation between the channel coefficients of the first symbol and the channel coefficients of the second symbol.

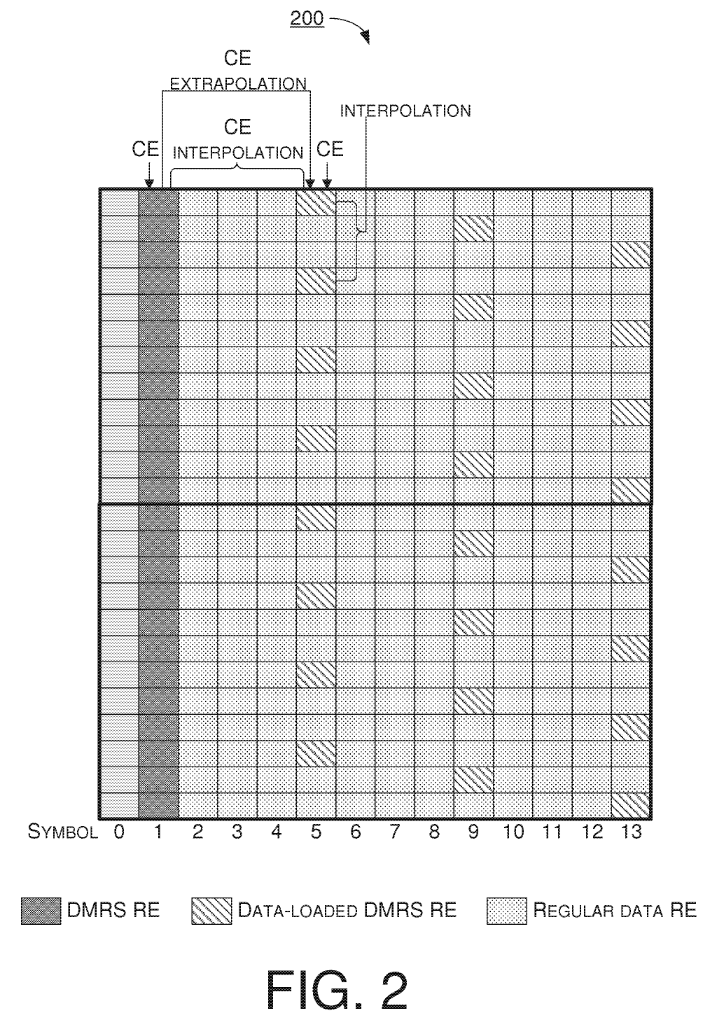

FIG. 2 illustrates an example scenario 200 under schemes in accordance with implementations of the present disclosure. For example, after configurations (i.e., the DMRS configuration and the configuration including the first RE time-frequency pattern and the second RE time-frequency pattern) between the UE and the network node, the following steps are performed for determining channel information. In step 0, the UE sets N = 1 (corresponding to a CORESET symbol number) and sets K = 0.

In step 1, the UE buffers the received PDSCH until an end of Orthogonal Frequency-Division Multiplexing (OFDM) symbol (N+4*K+4). In the first iteration, the UE buffers the received PDSCH until the end of OFDM symbol 5 before moving on to step 2.

In step 2, the UE performs Channel Estimation (CE)/Noise Estimation (NE) to obtain channel information associated with the OFDM symbol (N+4*K) using DMRS REs on the OFDM symbol (N+4*K). In the first iteration, the UE performs the CE/NE to obtain the channel information associated with OFDM symbol 1 using DMRS REs on OFDM symbol 1.

In step 3, the UE performs a CE extrapolation to obtain channel information associated with data-loaded DMRS REs, associated with the second RE time-frequency pattern, on OFDM symbol (N+4*K+4) using the channel information obtained in OFDM symbol (N+4*K) for data-loaded DMRS REs on OFDM symbol (N+4*K+4), and demodulates the data-loaded DMRS REs. In the first iteration, the UE performs the CE extrapolation to obtain channel information associated with the data-loaded DMRS REs on OFDM symbol 5 using the channel information obtained in OFDM symbol 1 for the data-loaded DMRS REs on OFDM symbol 5, and demodulates the data-loaded DMRS REs on OFDM symbol 5. The UE regenerates the data-loaded DMRS REs on OFDM symbol 5 by using the extrapolated channel information (i.e., the UE regenerates symbols corresponding to the data-loaded DMRS REs on OFDM symbol 5 by using the extrapolated channel information).

In step 4, the UE performs CE/NE to obtain channel information associated with data-loaded DMRS REs on OFDM symbol (N+4*K+4) using regenerated data-loaded DMRS REs on OFDM symbol (N+4*K+4). In the first iteration, the UE performs CE/NE to obtain the channel information associated with data-loaded DMRS REs on OFDM symbol 5 using regenerated data- loaded DMRS REs on OFDM symbol 5.

Further, the UE may perform an interpolation to obtain the channel information associated with regular data REs, associated with the first RE time- frequency pattern, on the OFDM symbol (N+4*K+4) based on the channel information obtained for data-loaded DMRS REs on the OFDM symbol (N+4*K+4). In the first iteration, the UE performs the interpolation to obtain the channel information associated with the regular data REs on OFDM symbol 5 based on channel information obtained for data-loaded DMRS REs on OFDM symbol 5.

In step 5, the UE performs a CE interpolation to obtain channel information associated with regular data REs on OFDM symbols (N+4*K+1), (N+4*K+2) and (N+4*K+3) using the channel information obtained in OFDM symbol (N+4*K) and (N+4*K+4). In the first iteration, the UE performs the CE interpolation to obtain the channel information associated with the regular data REs on OFDM symbols 2, 3 and 4 using the channel information obtained in OFDM symbol 1 and 5.

In step 6, the UE demodulates the regular data REs on OFDM symbol (N+4*K), (N+4*K+1), (N+4*K+2) and (N+4*K+3) using the channel information obtained in previous steps and, if necessary, the NE obtained in OFDM symbol (N+4*K). In the first iteration, the UE demodulates the regular data REs on OFDM symbol 1, 2, 3 and 4 using the channel information obtained in previous steps and, if necessary, the NE obtained in OFDM symbol 1.

In step 7, the UE updates K to (K+1). The UE buffers the received PDSCH until an end of OFDM symbol (N+4*K+4). Thereafter, a next iteration starts from step 3.

In some implementations, the portion of the plurality of REs on the second symbol may be demodulated without a Cyclic Redundancy Check (CRC). In other words, demodulation of the portion of the plurality of REs on the second symbol may be performed without CRC verification. For example, Multiple-Input Multiple-Output (MIMO) sphere decoding is applied to spatial layers on a per-RE basis.

In some implementations, a plurality of REs from a OFDM symbol of the second RE time-frequency pattern may be associated with an individual Code Block (CB) or Code Block Group (CBG). The individual CB or CBG may be mapped to a same OFDM symbol. In particular, the portion of the plurality of REs (i.e., the data-loaded DMRS REs), which is associated with the second RE time-frequency pattern, on the second symbol may be associated with a first CB or CBG, and data REs on the second symbol may be associated with a second CB or CBG. More specifically, the portion of the plurality of REs (i.e., the data-loaded DMRS REs) on the second symbol may be associated with CB(s) or CBG(s) that are independent of CBs or CBGs associated with regular data REs on the same symbol. In some implementations, the second RE time- frequency pattern may be mapped to a same OFDM symbol (i.e., mapped within a single OFDM symbol) and may not span multiple OFDM symbols. In some cases, other data REs may follow a per-N-symbol CBG principle, where N may be equal to 1, 2, or 4 symbols, based on indicated signaling.

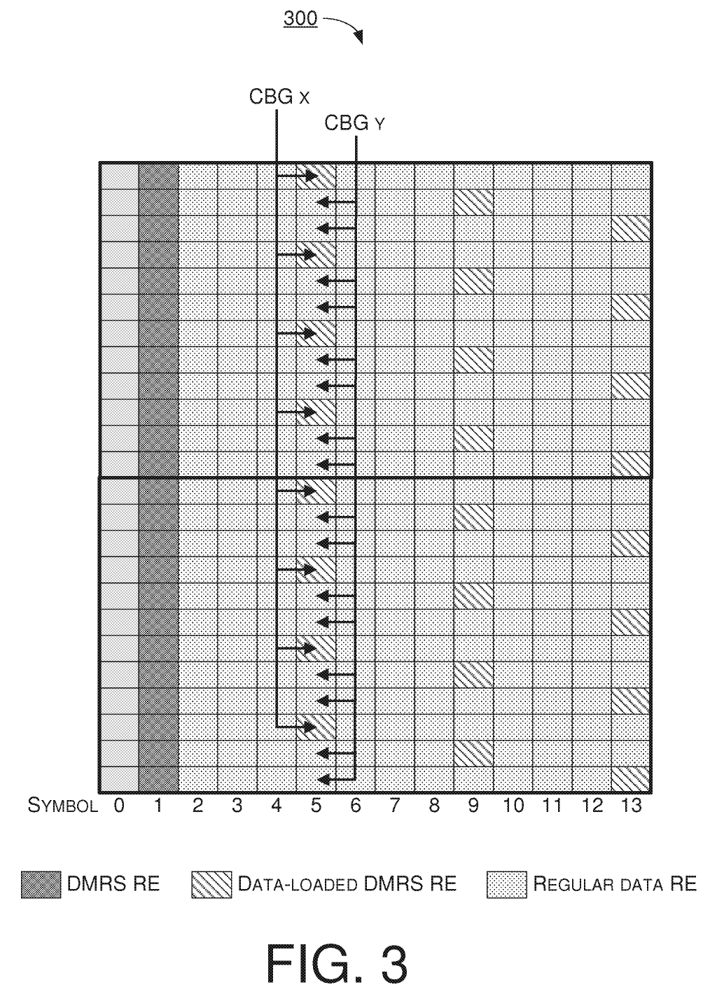

FIG. 3 illustrates an example scenario 300 under schemes in accordance with implementations of the present disclosure. For example, the data-loaded DMRS REs on the second symbol are associated with CBG x, and regular data REs on the second symbol are associated with CBG y.

In some implementations, the portion of the plurality of REs and the data REs on the second symbol may be associated with a same CB or CBG. In particular, the same CB(s) or CBGs may follow a per-N-symbol CBG principle, where N may be equal to 1, 2, or 4 symbols, as indicated by signaling. In some cases, N may be set to 1 for CB(s) or CBG(s) involving the portion of the plurality of REs (i.e., the data-loaded DMRS REs). CB(s) or CBG(s) not involving the portion of the plurality of REs (i.e., the data-loaded DMRS REs) may be associated with a different value of N based on configuration or other signaling.

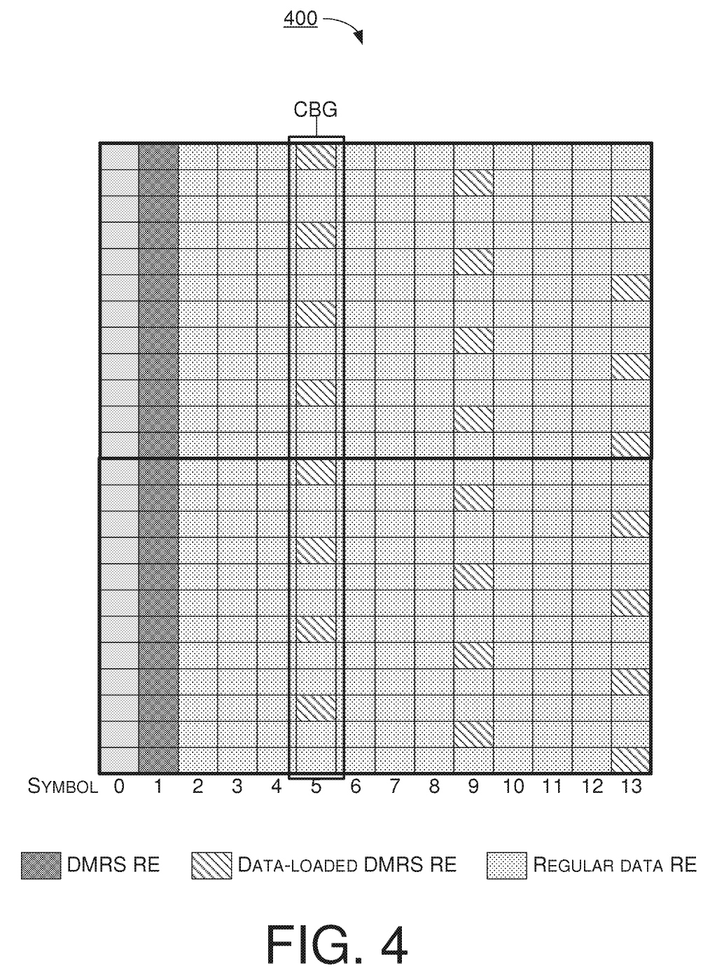

FIG. 4 illustrates an example scenario 400 under schemes in accordance with implementations of the present disclosure. For example, the data-loaded DMRS REs on the second symbol and the data REs on the second symbol are associated with the same CBG.

In some implementations, the portion of the plurality of REs (i.e., the data-loaded DMRS REs) may belong to CB(s) of CBG(s), and the corresponding CBG may include other CB(s) associated with regular data REs in a data-loaded symbol.

In some implementations, the first RE time-frequency pattern and the second RE time-frequency pattern may be associated with a CB or CBG. In particular, the CB or CBG may be shared between some data REs of the first RE time-frequency pattern and some data-loaded DMRS REs of the second RE time-frequency pattern.

In some implementations, the second equivalent code rate of the second RE time-frequency pattern may be configured based on a second modulation order lower than a first modulation order of the first equivalent code rate of the first RE time-frequency pattern. In some cases, the second equivalent code rate may be indicated by pre-configured Most Significant Bits (MSB) or Least Significant Bits (LSB). In some cases, the second modulation order of the second equivalent code rate may be fixed to a pre-configured modulation order.

In some implementations, the portion of the plurality of REs (i.e., the data-loaded DMRS REs) associated with the second RE time-frequency pattern may be associated with a lower-order modulation. For example, the lower-order modulation includes a set of pre-defined constellation points selected from a higher-order modulation. The set of constellation points is selected based on a predetermined metric, such as maximizing a Euclidean distance between the selected constellation points. Further, the set of constellation points is distributed across four quadrants and may be substantially uniform. For another example, the lower-order modulation includes the Quadrature Phase Shift Keying (QPSK) scheme.

In some implementations, the portion of the plurality of REs (i.e., the data-loaded DMRS REs) associated with the second RE time-frequency pattern may be associated with a same Modulation and Coding Scheme (MCS) as data REs on the second symbol, and a portion of modulation bits associated with the portion of the plurality of REs may be preconfigured (e.g., may be known by the UE). In some cases, the portion of modulation bits may include LSB, MSB, or preconfigured points on an indicated modulation constellation. The preconfigured points on the indicated modulation constellation may correspond to a subset of constellation points whose associated bit patterns are known or pre-determined, such that at least a portion of modulation bits carried by the constellation points is known to the UE.

For example, the data-loaded DMRS REs are modulated using a same Quadrature Amplitude Modulation (QAM) scheme as data REs, with the portion of modulation bits, starting from LSB, being known, except when the modulation scheme is QPSK. When the indicated MCS corresponds to a lower-order modulation such as QPSK, no modulation bits are pre-known for the data- loaded DMRS REs, and all modulation bits are treated as unknown in a same manner as regular data REs.

For another example, the portion of modulation bits is based on bits prior to Gray code mapping, which maps bits to constellation points such that adjacent constellation points differ by one bit, thereby increasing reliability in digital communication systems.

In some implementations, signaling for the foregoing modulations may follow a same MCS indication as that for a Transport Block (TB) associated with regular data REs on the same symbol. More specifically, the UE may assume a same modulation order and coding rate, as indicated by the MCS, for the data-loaded DMRS REs and the regular data REs on the same symbol.

In some cases, when the portion of the plurality of REs (i.e., the data- loaded DMRS REs) is associated with the lower-order modulation, the UE may assume that a portion of modulation bits, such as two MSB or two LSB, are unknown, while the remaining modulation bits are assumed to be preconfigured information (i.e., known bits).

In some cases, when the portion of the plurality of REs (i.e., the data- loaded DMRS REs) is associated with the same MCS as the data REs on the second symbol, and the portion of modulation bits associated with the portion of the plurality of REs is preconfigured, the UE may assume that a portion of modulation order bits, such as MSB or LSB, are unknown, while remaining modulation bits are assumed to be preconfigured information (i.e., known bits). In these cases, when the modulation scheme includes QPSK, the UE may assume a same modulation order for the portion of the plurality of REs (i.e., the data-loaded DMRS REs) and the regular data REs.

In some cases, for the determination of a TB size (TBS), the UE may assume a code rate corresponding to the indicated MCS. An actual code rate may be lower than the assumed code rate due to known bits carried in the portion of the plurality of REs (i.e., the data-loaded DMRS REs), which facilitate channel decoding of corresponding CBs.

In some implementations, with respect to signaling for the foregoing modulations, the unknown bits may correspond to a set of pre-defined constellation points selected from an indicated modulation order according to an MCS indication.

In some cases, the set of constellation points may be selected based on a predetermined distance metric, such as maximizing a Euclidean distance between selected constellation points. In some cases, the set of constellation points may be distributed across four quadrants and may be substantially uniform.

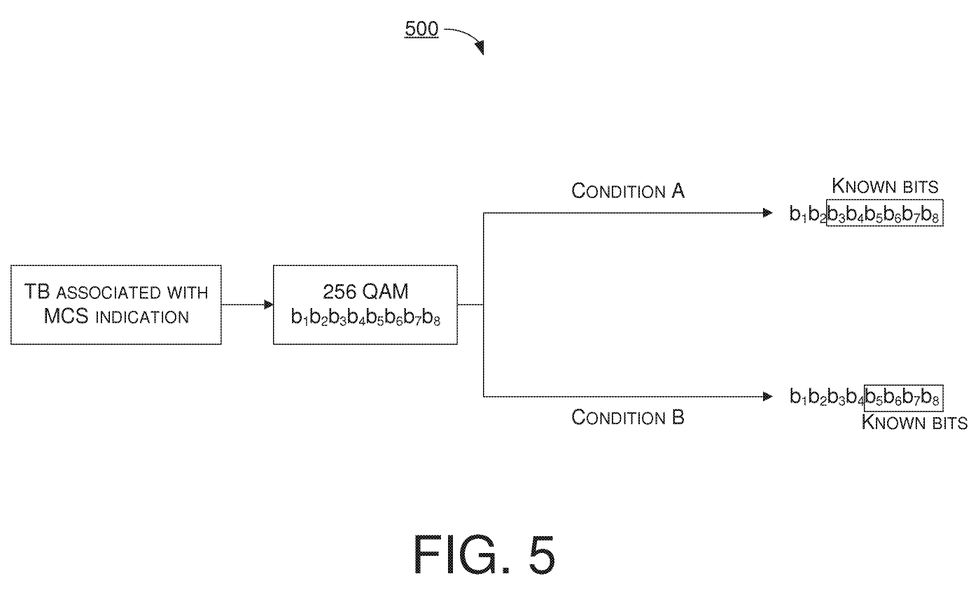

FIG. 5 illustrates an example scenario 500 under schemes in accordance with implementations of the present disclosure. For example, a TB is associated with an MCS indication, which specifies a modulation order for data transmission. In this example, the MCS indication corresponds to a higher-order modulation scheme, such as 256 QAM, in which each modulation symbol is represented by a plurality of modulation bits (e.g., b1 through b8). Based on the indicated modulation order, the modulation bits are conceptually divided into multiple portions.

When the portion of the plurality of REs (i.e., the data-loaded DMRS REs) is associated with the lower-order modulation (Condition A in FIG. 5), a first portion of the modulation bits (2 bits in this example) is treated as unknown bits that are subject to demodulation at the UE, while a second portion of the modulation bits (6 bits in this example) are treated as known bits.

When the portion of the plurality of REs (i.e., the data-loaded DMRS REs) is associated with the same MCS as the data REs on the second symbol, and the portion of modulation bits associated with the portion of the plurality of REs is preconfigured (Condition B in FIG. 5), the first portion of the modulation bits (half of 8 bits in this example) is treated as unknown bits that are subject to demodulation at the UE, while the second portion of the modulation bits (half of 8 bits in this example) are treated as known bits.

Accordingly, although the TB-level signaling indicates the use of the higher-order modulation scheme, the data-loaded DMRS REs effectively operate with a reduced uncertainty in the modulation domain. This constrained modulation behavior enables the receiver to perform more robust demodulation and to regenerate data-loaded DMRS symbols with improved reliability, thereby facilitating subsequent channel estimation without requiring additional MCS signaling or modification of the TB structure.

In some implementations, the portion of the plurality of REs (i.e., the data-loaded DMRS REs) may be associated with a first MCS, and the data REs on the second symbol may be associated with a second MCS. In some cases, CB(s) or CBG(s) associated with the portion of the plurality of REs (i.e., the data-loaded DMRS REs) may be different from regular data REs in the same symbol. In some cases, the network node may transmit a signaling (e.g., an additional field (s) in Downlink Control Information (DCI)) indicating the first MCS for the portion of the plurality of REs and the second MCS for the data REs.

In some implementations, the portion of the plurality of REs (i.e., the data-loaded DMRS REs) on the second symbol may be transmitted with increased power. In particular, the portion of the plurality of REs (i.e., the data- loaded DMRS REs) on the second RE time-frequency pattern may be power boosted relative to regular data REs on the same symbol. In some cases, a power boosting ratio may be signaled from the network to the UE, and the power boosting ratio may be the same as that applied to regular DMRS REs (e.g., the DMRS REs on the first symbol).

In some implementations, the first RE time-frequency pattern and the second RE time-frequency pattern may correspond to a same number of first spatial layers, and the first spatial layers may be the same as second spatial layers used for DMRS ports of the scheduled PDSCH. In particular, the data REs on the first RE time-frequency pattern and the portion of the plurality of REs (i.e., the data-loaded DMRS REs) on the second RE time-frequency pattern may have the same number of the first spatial layers, and the first spatial layers may be the same as the second spatial layers used for DMRS ports of the scheduled PDSCH.

In some cases, different antenna ports may be spatially multiplexed on the same REs as regular data REs, and spatial layer indication may follow that of the regular data REs. In such cases, different spatial layers of a same RE may be associated with different CBs, CBGs, or TBs.

In some cases, each portion of the plurality of REs (i.e., the data- loaded DMRS REs) may include a subset of spatial layers associated with regular data REs. In these cases, a data-loaded DMRS RE may use the subset of spatial layers to carry data information, and the subset may include one spatial layer. Different subsets of spatial layers may be non-overlapping, and all MIMO layers used by the regular data REs may be included across the different subsets of spatial layers.

In these cases, different subsets of spatial layers may be mapped to different data-loaded DMRS REs within a same symbol, such that all subsets of spatial layers are utilized. The different subsets of spatial layers may be arranged on contiguous data-loaded DMRS REs within the symbol. Further, different frequency portions of a PDSCH bandwidth may repeat all subsets of spatial layers. A mapping between data-loaded spatial layers and data-loaded DMRS REs may be signaled or configured in advance.

In some cases, a precoder may be assumed to be consistent between the portion of the plurality of REs (i.e., the data-loaded DMRS REs) and one or more preceding DMRS symbols.

In some implementations, the plurality of REs from the OFDM symbol of the second RE time-frequency may be associated with an independent Hybrid Automatic Repeat reQuest (HARQ) process. In particular, with respect to HARQ Acknowledgment (HARQ-ACK), the portion of the plurality of REs, included in the second RE time-frequency pattern, on the second symbol may be associated with one HARQ-ACK, and the data REs on the second symbol are associated with another HARQ-ACK. More specifically, additional CB(s) or CBG(s) associated with the portion of the plurality of REs (i.e., the data-loaded DMRS REs) may belong to a different TB. Accordingly, an additional HARQ- ACK bit may be required for the different TB.

In some implementations, with respect to HARQ-ACK, the portion of the plurality of REs (i.e., the data-loaded DMRS REs) and regular data REs may share a same CB or CBG. Accordingly, a same HARQ-ACK bit may be used for both the data-loaded DMRS REs and the regular data REs.

In some implementations, the network node may transmit a signaling indicating a pattern of the portion of the plurality of REs to the UE. The UE may receive the signaling. In particular, after receiving signaling indicating the pattern, the UE may determine where to apply a modulation order constraint. In some cases, the pattern may adjust both a frequency-domain density and a time-domain density of REs. In some cases, the pattern may have a same frequency-domain density across data-loaded DMRS RE symbols, while having a frequency offset between the data-loaded DMRS RE symbols.

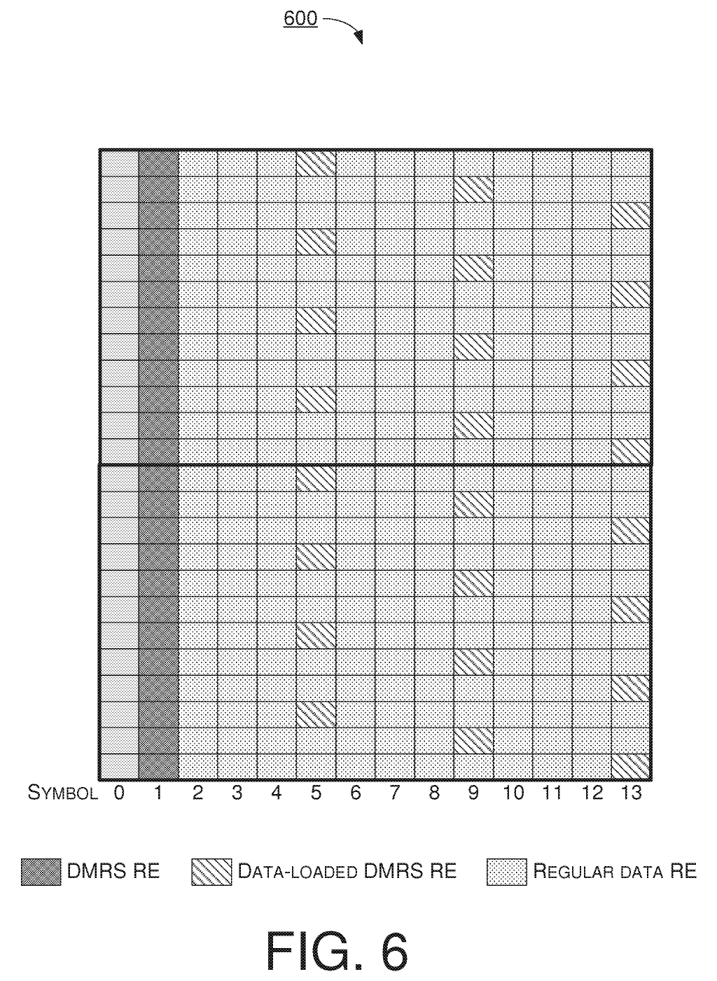

FIG. 6 illustrates an example scenario 600 under schemes in accordance with implementations of the present disclosure. For example, a pattern of a PDSCH transmitted from the network node to the UE is illustrated in FIG. 6. The second RE time-frequency pattern may be associated with a subset of OFDM symbols (i.e., symbols 5, 9 and 13).

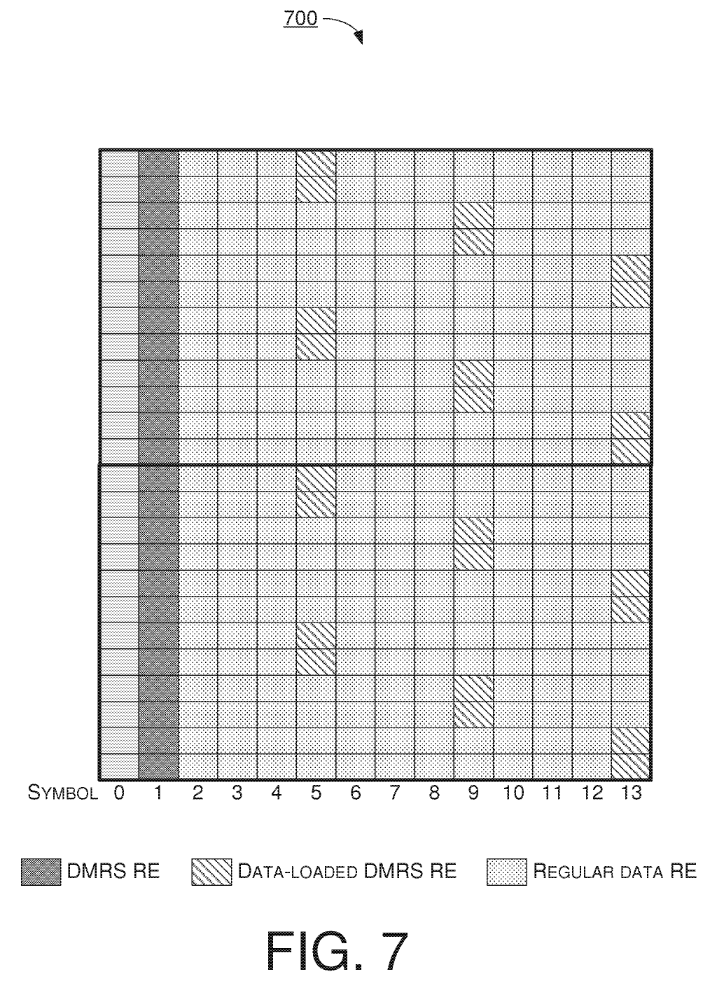

FIG. 7 illustrates an example scenario 700 under schemes in accordance with implementations of the present disclosure. For example, a pattern of a PDSCH transmitted from the network node to the UE is illustrated in FIG. 7. The second RE time-frequency pattern may be associated with a subset of OFDM symbols (i.e., symbols 5, 9 and 13)

In some implementations, with respect to the foregoing pattern, for each UE antenna port, a received signal may be a superposition of information from multiple spatial layers, which may be expressed as a linear combination of multi-layer channel coefficients and corresponding layer signals. The UE may require multiple such observations, for example, from different data-loaded DMRS REs, in order to recover channel coefficient information associated with multiple spatial layers. Such multiple observations for channel coefficient estimation at a UE antenna port may preferably be obtained within a coherent bandwidth. For example, the pattern illustrated in FIG. 7 may be beneficial for this purpose.

### Illustrative Implementations

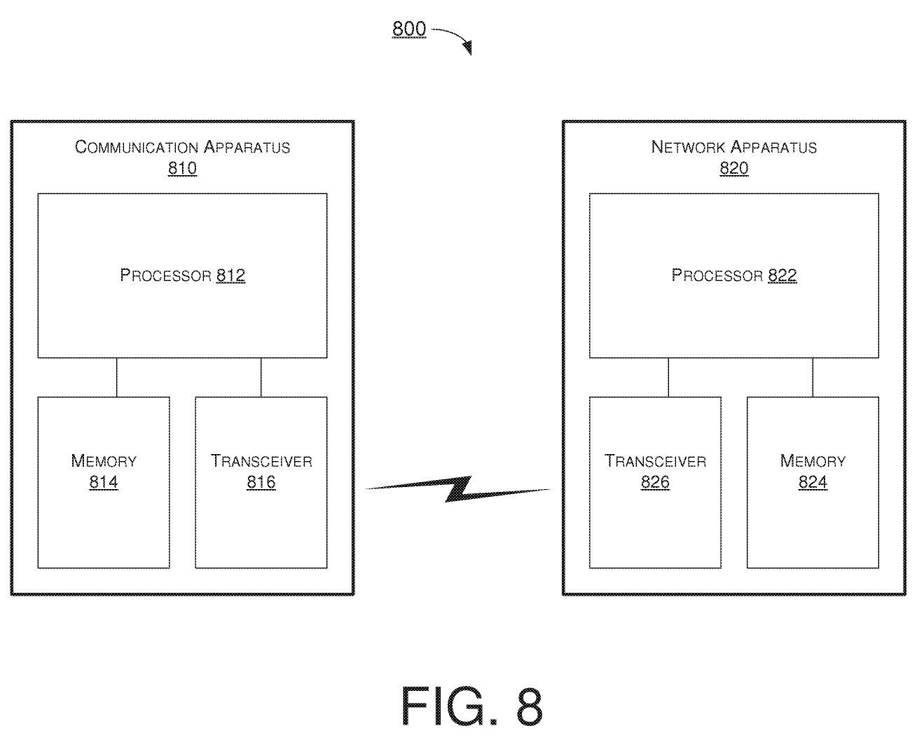

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to receiving data channel with respect to UE and network apparatus in mobile communications, including scenarios/schemes described above as well as processes 900 and 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, a digital camera, or a computing equipment such as a tablet computer, a laptop computer or a notebook computer. Communication apparatus 810 may also be a part of a machine type apparatus, which may be an loT, NB-loT, or IloT apparatus such as an immobile or a stationary apparatus, a home apparatus, a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed scheme of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of a network apparatus, which may be a network node such as a satellite, a base station, a small cell, a router or a gateway. For instance, network apparatus 820 may be implemented in an eNodeB in an LTE network, in a gNB in a 5G/NR, IoT, NB-loT or IloT network or in a satellite or base station in a 6G network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term "a processor" is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks including receiving data channel in a device (e.g., as represented by communication apparatus 810) and a network (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In other words, processor 812 may transceive the data such as configuration, message, signal, information, indicator, etc. via transceiver 816. In some implementations, communication apparatus 810 may further include a memory 814 coupled to processor 812 and capable of being accessed by processor 812 and storing data therein. In some implementations, network apparatus 820 may also include a transceiver 826 coupled to processor 822 and capable of wirelessly transmitting and receiving data. In other words, processor 822 may transceive the data such as configuration, message, signal, information, indicator, etc. via transceiver 826. In some implementations, network apparatus 820 may further include a memory 824 coupled to processor 822 and capable of being accessed by processor 822 and storing data therein. Accordingly, communication apparatus 810 and network apparatus 820 may wirelessly communicate with each other via transceiver 816 and transceiver 826, respectively. To aid better understanding, the following description of the operations, functionalities and capabilities of each of communication apparatus 810 and network apparatus 820 is provided in the context of a mobile communication environment in which communication apparatus 810 is implemented in or as a communication apparatus or a UE and network apparatus 820 is implemented in or as a network node of a communication network.

In some implementations, each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non- volatile random-access memory (NVRAM) such as flash memory, solid-state memory, ferroelectric RAM (FeRAM), magnetoresistive RAM (MRAM) and/or phase-change memory.

Communication apparatus 810 may include components of virtual UEs, which may be independently virtualized by hardware (e.g., processor 812, memory 814, and transceiver 816) of communication apparatus 810, such that the components of the virtual UEs are recognized by network apparatus 820 as independent UE entities.

### Illustrative Processes

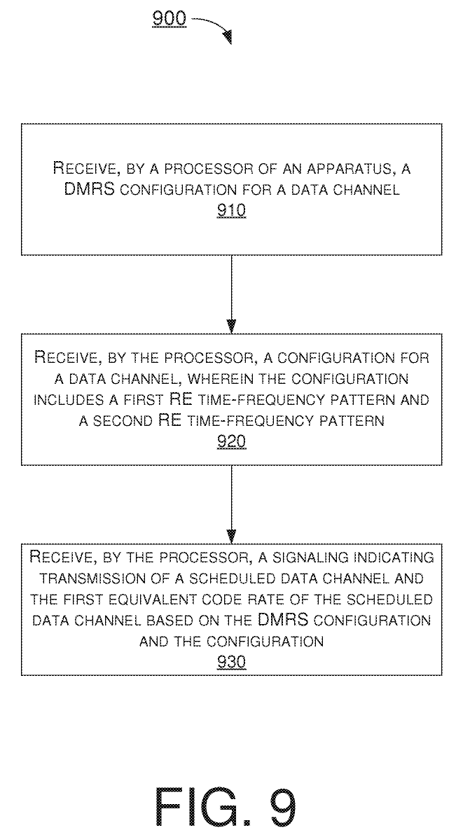

FIG. 9 illustrates an example process 900 in accordance with an implementation of the present disclosure. Process 900 may be an example implementation of above scenarios/schemes, whether partially or completely, with respect to receiving data channel of the present disclosure. Process 900 may represent an aspect of implementation of features of communication apparatus 810. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 810 or any suitable UE or machine type devices. Solely for illustrative purposes and without limitation, process 900 is described below in the context of communication apparatus 810. Process 900 may begin at block 910.

At block 910, process 900 may involve processor 812 of communication apparatus 810 receiving a DMRS configuration for a data channel. Process 900 may proceed from block 910 to block 920.

At block 920, process 900 may involve processor 812 of communication apparatus 810 receiving a configuration for the data channel. The configuration may include: (1) a first RE time-frequency pattern of the data channel, wherein the first RE time-frequency pattern may be associated with a first equivalent code rate, and (2) a second RE time-frequency pattern of the data channel, wherein the second RE time-frequency pattern may be associated with a second equivalent code rate which is lower than the first equivalent code rate, the second RE time-frequency pattern may be associated with a subset of OFDM symbols of the data channel, and the first RE time- frequency pattern and the second RE time-frequency pattern may be used for transmission of the data channel. Process 900 may proceed from block 920 to block 930.

At block 930, process 900 may involve processor 812 of communication apparatus 810 receiving a signaling indicating transmission of a scheduled data channel and the first equivalent code rate of the scheduled data channel based on the DMRS configuration and the configuration.

In some implementations, a plurality of REs from an OFDM symbol of the second RE time-frequency pattern may be associated with an individual CB or CBG.

In some implementations, the individual CB or CBG may be mapped to a same OFDM symbol.

In some implementations, the plurality of REs from the OFDM symbol of the second RE time-frequency may be associated with an independent HARQ process.

In some implementations, the first RE time-frequency pattern and the second RE time-frequency pattern may be associated with a CB or CBG. In some implementations, the second equivalent code rate may be configured based on a second modulation order lower than a first modulation order of the first equivalent code rate.

In some implementations, the second equivalent code rate may be indicated by pre-configured MSB or LSB.

In some implementations, the second equivalent code rate may be indicated based on a pre-configured set of constellation points.

In some implementations, the second modulation order of the second equivalent code rate may be fixed to a pre-configured modulation order.

In some implementations, REs on the second RE time-frequency pattern may be power boosted compared to REs on the first RE time-frequency pattern.

In some implementations, the first RE time-frequency pattern and the second RE time-frequency pattern may correspond to a same number of first spatial layers, and the first spatial layers may be the same as second spatial layers used for DMRS ports of a scheduled data channel.

In some implementations, the second RE time-frequency pattern may correspond to a subset of first spatial layers associated with the first RE time- frequency pattern, and the first spatial layers are the same as second spatial layers used for DMRS ports of a scheduled data channel.

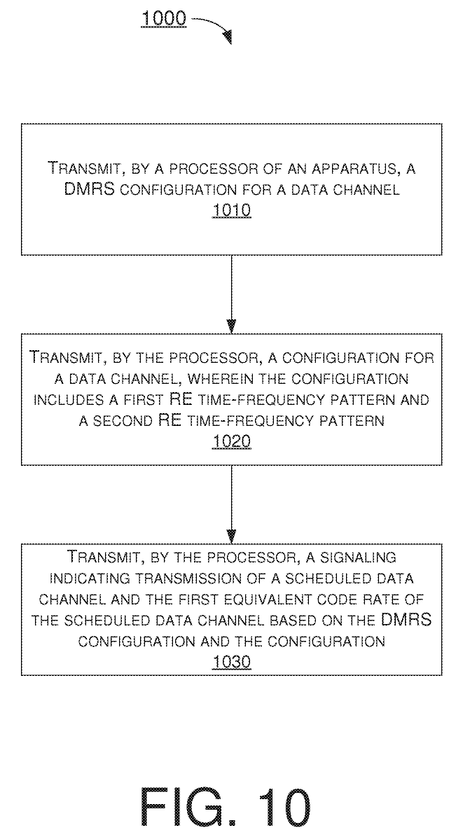

FIG. 10 illustrates an example process 1000 in accordance with an implementation of the present disclosure. Process 1000 may be an example implementation of above scenarios/schemes, whether partially or completely, with respect to receiving data channel of the present disclosure. Process 1000 may represent an aspect of implementation of features of network apparatus 820. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820 or any suitable network device or machine type devices. Solely for illustrative purposes and without limitation, process 1000 is described below in the context of network apparatus 820. Process 1000 may begin at block 1010.

At block 1010, process 1000 may involve processor 822 of network apparatus 820 transmitting a DMRS configuration for a data channel. Process 1000 may proceed from block 1010 to block 1020.

At block 1020, process 1000 may involve processor 822 of network apparatus 820 transmitting a configuration for the data channel. The configuration may include: (1) a first RE time-frequency pattern of the data channel, wherein the first RE time-frequency pattern may be associated with a first equivalent code rate, and (2) a second RE time-frequency pattern of the data channel, wherein the second RE time-frequency pattern may be associated with a second equivalent code rate which is lower than the first equivalent code rate, the second RE time-frequency pattern may be associated with a subset of OFDM symbols of the data channel, and the first RE time- frequency pattern and the second RE time-frequency pattern may be used for transmission of the data channel. Process 1000 may proceed from block 1020 to block 1030.

At block 1030, process 1000 may involve processor 822 of network apparatus 820 transmitting a signaling indicating transmission of a scheduled data channel and the first equivalent code rate of the scheduled data channel based on the DMRS configuration and the configuration.

In some implementations, a plurality of REs from an OFDM symbol of the second RE time-frequency pattern may be associated with an individual CB or CBG.

In some implementations, the individual CB or CBG may be mapped to a same OFDM symbol.

In some implementations, the plurality of REs from the OFDM symbol of the second RE time-frequency may be associated with an independent HARQ process.

In some implementations, the first RE time-frequency pattern and the second RE time-frequency pattern may be associated with a CB or CBG.

In some implementations, the second equivalent code rate may be configured based on a second modulation order lower than a first modulation order of the first equivalent code rate.

In some implementations, the second equivalent code rate may be indicated by pre-configured MSB or LSB or be indicated based on a pre- configured set of constellation points.

In some implementations, REs on the second RE time-frequency pattern may be power boosted.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as "open" terms, e.g., the term "including" should be interpreted as "including but not limited to," the term "having" should be interpreted as "having at least," the term "includes" should be interpreted as "includes but is not limited to," etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., "a" and/or "an" should be interpreted to mean "at least one" or "one or more;" the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to "at least one of A, B, and C, etc." is used, in general such a construction is intended in the sense one having skill in the art would understand the convention, e.g., "a system having at least one of A, B, and C" would include but not be limited to systems that have A alone, B alone, C alone, A and B together, A and C together, B and C together, and/or A, B, and C together, etc. In those instances where a convention analogous to "at least one of A, B, or C, etc." is used, in general such a construction is intended in the sense one having skill in the art would understand the convention, e.g., "a system having at least one of A, B, or C" would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B."

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a Demodulation Reference Signal (DMRS) configuration for a data channel;
receiving, by the processor, a configuration for the data channel, wherein the configuration includes:
a first Resource Element (RE) time-frequency pattern of the data channel, wherein the first RE time-frequency pattern is associated with a first equivalent code rate; and
a second RE time-frequency pattern of the data channel, wherein the second RE time-frequency pattern is associated with a second equivalent code rate which is lower than the first equivalent code rate, wherein the second RE time-frequency pattern is associated with a subset of Orthogonal Frequency Division Multiplexing (OFDM) symbols of the data channel, and wherein the first RE time-frequency pattern and the second RE time-frequency pattern are used for transmission of the data channel; and
receiving, by the processor, a signaling indicating transmission of a scheduled data channel and the first equivalent code rate of the scheduled data channel based on the DMRS configuration and the configuration.

2. The method of claim 1, wherein a plurality of REs from an OFDM symbol of the second RE time-frequency pattern is associated with an individual Code Block (CB) or Code Block Group (CBG).

3. The method of claim 2, wherein the individual CB or CBG is mapped to a same OFDM symbol.

4. The method of claim 2, wherein the plurality of REs from the OFDM symbol of the second RE time-frequency is associated with an independent Hybrid Automatic Repeat reQuest (HARQ) process.

5. The method of claim 1, wherein the first RE time-frequency pattern and the second RE time-frequency pattern are associated with a Code Block (CB) or Code Block Group (CBG).

6. The method of claim 1, wherein the second equivalent code rate is configured based on a second modulation order lower than a first modulation order of the first equivalent code rate.

7. The method of claim 6, wherein the second equivalent code rate is indicated by pre-configured Most Significant Bits (MSB) or Least Significant Bits (LSB).

8. The method of claim 6, wherein the second equivalent code rate is indicated based on a pre-configured set of constellation points.

9. The method of claim 6, wherein the second modulation order of the second equivalent code rate is fixed to a pre-configured modulation order.

10. The method of claim 1, wherein REs on the second RE time- frequency pattern are power boosted compared to REs on the first RE time- frequency pattern.

11. The method of claim 1, wherein the first RE time-frequency pattern and the second RE time-frequency pattern correspond to a same number of first spatial layers, and the first spatial layers are the same as second spatial layers used for DMRS ports of a scheduled data channel.

12. The method of claim 1, wherein the second RE time-frequency pattern corresponds to a subset of first spatial layers associated with the first RE time-frequency pattern, and the first spatial layers are the same as second spatial layers used for DMRS ports of a scheduled data channel.

13. A method, comprising:
transmitting, by a processor of an apparatus, a Demodulation Reference Signal (DMRS) configuration for a data channel;
transmitting, by the processor, a configuration for the data channel, wherein the configuration includes:
a first Resource Element (RE) time-frequency pattern of the data channel, wherein the first RE time-frequency pattern is associated with a first equivalent code rate; and
a second RE time-frequency pattern of the data channel, wherein the second RE time-frequency pattern is associated with a second equivalent code rate which is lower than the first equivalent code rate, wherein the second RE time-frequency pattern is associated with a subset of Orthogonal Frequency Division Multiplexing (OFDM) symbols of the data channel, and wherein the first RE time-frequency pattern and the second RE time-frequency pattern are used for transmission of the data channel; and
transmitting, by the processor, a signaling indicating transmission of a scheduled data channel and the first equivalent code rate of the scheduled data channel based on the DMRS configuration and the configuration.

14. The method of claim 13, wherein a plurality of REs from an OFDM symbol of the second RE time-frequency pattern is associated with an individual Code Block (CB) or Code Block Group (CBG).

15. The method of claim 14, wherein the individual CB or CBG is mapped to a same OFDM symbol.

16. The method of claim 14, wherein the plurality of REs from the OFDM symbol of the second RE time-frequency pattern is associated with an independent Hybrid Automatic Repeat reQuest (HARQ) process.

17. The method of claim 13, wherein the first RE time-frequency pattern and the second RE time-frequency pattern are associated with a CodeBlock (CB) or Code Block Group (CBG).

18. The method of claim 13, wherein the second equivalent code rate is configured based on a second modulation order lower than a first modulation order of the first equivalent code rate.

19. The method of claim 18, wherein the second equivalent code rate is indicated by pre-configured Most Significant Bits (MSB) or Least Significant Bits (LSB), or is indicated based on a pre-configured set of constellation points.

20. The method of claim 13, wherein REs on the second RE time- frequency pattern are power boosted compared to REs on the first RE time- frequency pattern.
